(19) United States
(12) Patent Application Publication
(10) Pub. No.: US 2016/0348645 A1
(43) Pub. Date: Dec. 1, 2016

(54) WIND GENERATOR TURBINE

(71) Applicant: Gevorg Serezaevih NOROYAN, MOSCOW (RU)

(72) Inventor: Gevorg Serezaevih NOROYAN, MOSCOW (RU)

(21) Appl. No.: 15/114,813

(22) PCT Filed: Dec. 11, 2014
(86) PCT No.: PCT/EA2014/000022

§ 371 Date: Jul. 27, 2016

(30) Foreign Application Priority Data
Jan. 30, 2014 (EA) 201400083

(51) Int. Cl. F03D 3/06; F03D 3/00

(52) U.S. Cl. CPC F03D 3/061; F03D 3/005; F05B 2240/218; F05B 2220/30; F05B 2250/13

(57) ABSTRACT

The group of inventions relates to wind energy, and more particularly to variants of wind generators intended for use in wind power facilities of different capacities. The present turbine comprises radial vanes connected to a disc that is mounted on a shaft, each vane consisting of an upper airfoil and a lower airfoil with intermediary airfoils fastened therebetween. The upper airfoils are inclined in one direction so that one side thereof constitutes an air inlet. The lower airfoils are inclined in the opposite direction. According to a second variant, the intermediary airfoils are mounted vertically or at an angle to the upper airfoil. The invention is directed to increasing the production of electrical energy in wind-powered electricity generators.

### CROSS-REFERENCE TO RELATED APPLICATION

This application is a national stage patent application arising from PCT/EA2014/000022 filed on Dec. 11, 2014, and referenced in WIPO Publication No. WO 2015/113572. The earliest priority date claimed is Jan. 30, 2014.

### FEDERALLY SPONSORED RESEARCH

None

### SEQUENCE LISTING OR PROGRAM

None

### BACKGROUND

The group of inventions is related to wind energy, particularly to various wind generators, designed to be used in wind generating facilities of various capacities, on hills, in prairies, in residential and commercial buildings, on water and ground transportations.

There is a known wind turbine with vertical axis and radial air chambers, consisting of a disk, equipped with upper and lower radial blades and external blades. When the disk is rotated, the abovementioned blades maximally spread out and form a number of air chambers. Sections, rotating in opposite direction, have minimum friction resistance forces due to blades being folded (PCT/KR 09/0808, <<Global inventions>>, 66th issue La 8/201 1).

The deficiency of this benchmarked solution is comparatively low work area of blades and large noise when external blades unfold, as well as an air pocket may occur. The technical result for both invention options is an increase in electricity output from wind generators due to an increase in turbine's work area, which consists of areas of upper, lower and intermediary airfoils (first option), as well as increase in pressure on the turbine due to additional airfoils (second option).

The technical result is achieved due to the following features. The first option of turbine invention for a wind generator, just like in the benchmarked solution, consists of radial blades, connected to the disk, located on the shaft.

Unlike the benchmarked solution, every blade, in the proposed solution, consists of upper and lower airfoils, with intermediary airfoils, attached between them. Upper airfoils are inclined to one side, so their other side (tail) can become an air inlet. Upper airfoils partially cover each other. Lower airfoils are inclined in the opposite direction of the upper ones.

Intermediary airfoils are in the shape of trapezoids and positioned vertically or at angle in relation to the upper airfoil, while their front lower part is positioned toward the center of the turbine to ensure the airflow is directed toward the center of the turbine.

The length of each intermediary airfoil may be equal to the blade width in a place, where it is installed.

The second option of the invention has the length of each intermediary airfoil less than the blade width in a place, where it is installed. In this invention option, intermediary airfoils are installed more frequently than in a previous option.

A device to adjust an angle between the shaft and blades can be installed on the shaft. Also, another device to adjust an angle to intake air by blades from 0° to 60°, i.e. to turn blades. For larger sized turbines, wheels can be installed under the blades, which move along special paths with a limiting rim, preventing the wind from lifting blades. Using intermediary airfoils, blades are built as lattice-work.

The second option of the turbine invention for a wind generator, as well the benchmarked solution, consists of radial blades, connected to the disk, located on the shaft.

Unlike the benchmarked solution, each blade in the second option of the proposed solution consists of the upper and lower airfoil and partially cover each other. Lower airfoils are inclined in the opposite direction of the upper ones. Intermediary airfoils are positioned vertically or at angle in relation to the upper airfoil. To ensure the stability of the turbine, its shaft is fastened on the spot, using beams with support stands, fastened with tightened cables, while additional airfoils are attached to the beam and support stand.

Additional airfoils may come in L-shape. In this case, each additional airfoil consists of two flat rectangles, connected mechanically between each other, one of which is positioned horizontally and fastened to a beam, while another one is positioned vertically and fastened to a stand. Additional airfoils can be installed at a 45° angle.

### DRAWINGS

The invention is described by the drawing, where the second option turbine shown in FIG. 1 (top view);

FIG. 2 shows the same, but sectional view.

The following design components are shown at positions.
1—upper airfoil;
2—intermediary airfoils;
3—last (outermost) intermediary airfoil;
4—lower airfoil;
5—device responsible for lifting lowering blades;
6—device responsible for turning blades;
7—cup, to which a beam for additional airfoils is fastened;
8—shaft;
9—handles of the abovementioned devices;
10—levers, connecting the above devices with blade;
11—pulley;
12—bearings;
13—beam, connecting cup 7, installed on the shaft, with support stands with cables;
14—horizontal part of the additional airfoil;
15—vertical part of the additional airfoil;
16—disk, to which blades are fastened;
17—support stands for cables;
18—pivot axle, connecting the blade with the disk;
19—axle, on which a blade is turning;
20—tightening cable;
21—protective cover.

### DESCRIPTION

As shown on FIG. 1, turbine blades are fastened around disk 16. Their number depends on the size of the turbine, as well as on the blades width, and respectively, the more blades, the more they will cover each other.

Upper airfoils 1 are positioned at an angle to the horizontal plane and partially cover each other. Their incline angle, on which the turbine blades depend on to intake air, can be adjusted.

Intermediary airfoils 2 are in the shape of trapezoids. They are mechanically fastened onto upper airfoils and can be positioned at any angle in relation to them. Intermediary airfoils take on a significant amount of pressure, resisting the wind. At the same time, they are hard ribs of the blades, similar to lattice work in construction. Intermediary airfoils are positioned by the least base of a trapezoid closer to the center of the turbine, thus ensuring the airflow direction toward its center.

Intermediary airfoils 2 can be installed along the entire length of the upper airfoil or they can be designed shorter. In the latter case, their more frequent installation is required.

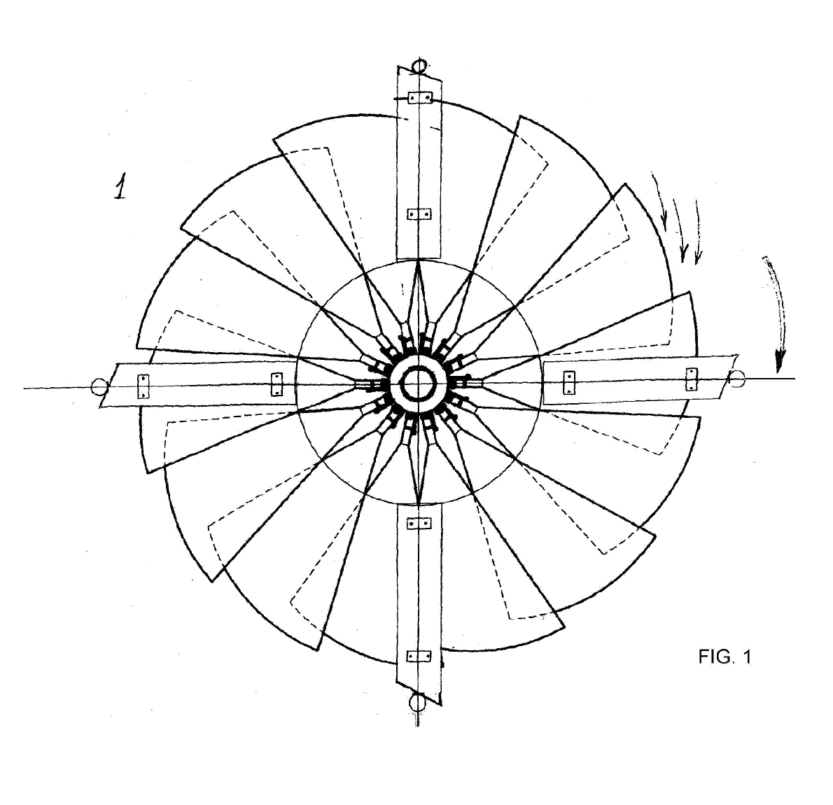

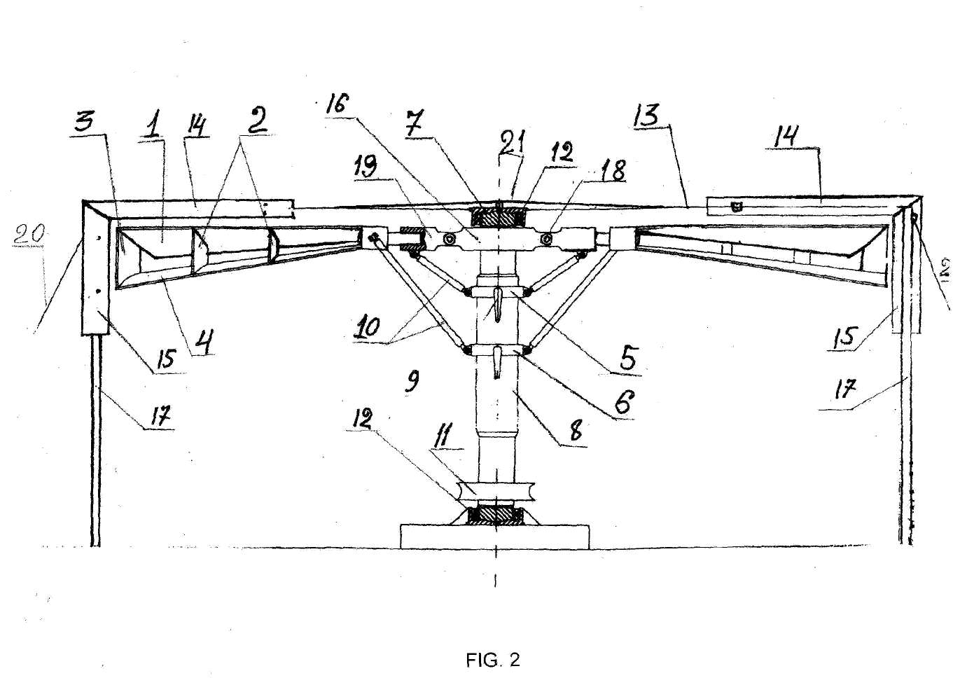

The last intermediary airfoil 3, positioned at the edge of the outer part of each blade, is designed to jut out, unlike the previous blade (FIGS. 1 and 2), and intakes air along its entire height. The presence of intermediary airfoils in turbine blades, according to the proposed solution, plays an important role in achieving the claimed invention's technical result, therefore, the height, length and incline angles, relative to upper airfoils, for each turbine are calculated individually.

Lower airfoils 4 are positioned under the intermediary airfoils and mechanically fastened to them. Lower airfoils are inclined in the direction that is opposite to upper airfoils incline. Not only do they resist airflow, adding work area, but prevent blades from lifting up by the wind, since the wind pushes down on them. Lower airfoils are designed to be narrower than upper ones.

There is a little bit of space for the outlet of processed airflow between lower airfoils, as well as to ensure safety while folding blades during storms, since, as it already have been mentioned, air pushes down on these airfoils, which prevents blades from lifting up due to the wind.

Two controlling devices 5 and 6 are installed on shaft 8. These devices are connected by levers 10 with each blade. One of the devices controls the angle of airflow intake by upper airfoil of blades (0° to 60°), and the second one controls the angle between the shaft and blades, lowering blades during strong winds. Devices are designed either as mechanical or hydraulic, ensuring safety of turbine operation.

Upper part of the shaft 8 can be fastened on the spot, where the turbine is installed and fastened by tightened cables 20. In this case, cup 7, positioned on the bearing with an orifice for the beam 13, is placed atop the shaft. On sides of the turbine, at least at three of its sides, support stands 17, with loops for cables 20 in their upper parts, are installed. Cup 7 is connected to stands 17 by beams 13, which have additional, for example, L-shaped airfoils fastened on them. Longer horizontal parts 14 of additional airfoils are fastened to the beam at an angle, repeating the incline angle of upper airfoils 1, for example, equivalent to 45°. Shorter vertical parts 15 of additional airfoils are fastened to support stands 17 with an incline toward the same direction as the last intermediary airfoils 3, also equivalent to 45°, for example.

Each additional airfoil is designed as two flat elastic rectangles, connected to each other or standing alone. The length and width of parts 14 and 15 of additional airfoils can vary and depend on turbine characteristics.

Support stands 17, fastened by tightened cables 20 with the spot and shaft 8 of the turbine, ensure assembly stability.

Taking into account a height adjustment of blades positions, the proposed design can also adjust support stands height. The tin cover 21 may be positioned above the central part of the turbine, protecting the turbines against atmospheric precipitations.

For larger turbines, where it is impossible to use tightened cables, wheels are installed under blades, while a path with a limiting edge is designed underneath them, which prevents blades from lifting up during strong winds. There could be several wheels and paths, corresponding to them. The proposed design of turbine blades, with abovementioned airfoils, increase work area of the turbine, which consists of areas of upper, lower and intermediary airfoils, thus ensuring an increased pressure on the turbine from the direction of the airflow. As a result, a maximum wind resistance occurs in compartments that turn to the direction of the wind, and turbine from another side, which turns against the wind, the mentioned airfoils repulse airflow, thus reducing its pressure on turbine blades.

The turbine works in the following way. The incoming airflow gets under upper airfoils 1, particularly into compartments, formed between the last intermediary airfoils 3, as shown by arrows on Fig. L. Upper airfoils 1 compress and direct airflow down into the turbine, while intermediary airfoils 2 and 3 compress and direct airflow toward the turbine center. Passing through two barriers, the airflow meets lower airfoils 4, which, in turn, direct airflow up, but passing through the lower airfoil, a part of the airflow exits from turbine blades through an air duct, formed in the gap between upper and lower airfoils and gets into the next blade, and part of the airflow remains in the compartment, creating additional pressure. At the same time, the airflow from parts 14 and 15 of additional airfoils from the top and the side is supplied to the turbine, which increase wind pressure on the turbine. Additional airfoils, located in the area of the turbine, where it rotates against the wind, repulses wind from the turbine, partially reducing wind impact on the turbine. To ensure the assembly stability of the turbine, its blades are designed as lattice-work by placing intermediary airfoils at angle to the upper airfoil, forming a broken line from them.

What is claimed:

1. A wind generator turbine, consisting of radial blades, connected to the disk, positioned on the shaft. Furthermore, each blade consists of upper and lower airfoils, with intermediary airfoils fastened between them, while upper airfoils are positioned at an angle in one direction in such a way that of their sides becomes air intake, and partially cover each other, and lower airfoils are positioned at angle in the opposite direction. Intermediary airfoils are in the shape of a trapezoid and placed vertically or at an angle in relation to the upper airfoil and their lower part is close to the turbine center to ensure airflow direction toward the turbine center.

2. The turbine according to claim 1, differing by having the length of each intermediary airfoil equal to the blade width in a place, where it is installed.

3. The turbine according to claim 1, differing by having the length of each intermediary airfoil less than the blade width in a place, where it is installed, while intermediary airfoils are installed more frequently.

4. The turbine according to claim 1, differing by having two devices on the shaft. The first one adjusts an angle between the shaft and blades, while the second one adjusts an angle of air intake by blades from 0° to 60°.

5. The turbine according to claim 1, differing by having wheels under the blades, which move along special paths with a limiting edge, preventing blades from lifting up due to strong winds.

6. The turbine according to claim 1, differing by having intermediary airfoils designed as lattice work to ensure design stability.

7. A wind generator turbine, consisting of radial blades, connected to the disk, positioned on the shaft. Furthermore, each blade consists of upper and lower airfoils, with intermediary airfoils fastened between them, while upper airfoils are positioned at an angle in one direction, and partially cover each other, and lower airfoils are positioned at angle in the opposite direction of upper ones. Intermediary airfoils are placed vertically or at an angle in relation to the upper airfoil and the shaft is fastened on the spot by beams, fastened to support stands by tightened cables, and also additional airfoils are fastened to the beam and support stand.
